(19) United States
(12) Patent Application Publication
(10) Pub. No.: US 2003/0095072 A1
(43) Pub. Date: May 22, 2003

(54) Antenna electrode for inductively coupled plasma generation apparatus

(76) Inventors: Gi-Chung Kwon, Gyeonggi-do (KR); Jeong-Beom Lee, Gyeonggi-do (KR); Hong-Sik Byun, Gyeonggi-do (KR)

Correspondence Address: LEWIS F. GOULD, JR., DUANE MORRIS LLP, ONE LIBERTY PLACE, PHILADELPHIA, PA, 19103, US

(21) Appl. No.: 10/298,078

(22) Filed: Nov. 15, 2002

(30) Foreign Application Priority Data
Nov. 19, 2001 (KR) 2001-71855

(51) Int. Cl. H01Q 1/00

(52) U.S. Cl. 343/720

(57) ABSTRACT

An antenna electrode for an inductively coupled plasma generation apparatus includes: a copper tube; a silver layer on an outer surface of the copper tube; and a first insulating layer on the silver layer. On the other hand, an antenna electrode for an inductively coupled plasma generation apparatus includes: an oxygen-free copper tube; and a first insulating layer on an outer surface of the oxygen-free copper tube.

This application claims the benefit of Korean Patent Application No. 2001-71855, filed on Nov. 19, 2001 in Korea, which is hereby incorporated by reference for all purposes as if fully set forth herein.

### BACKGROUND OF THE INVENTION

1. Field of the Invention

The present invention relates to an antenna electrode and more particularly, to an antenna electrode for an inductively coupled plasma generation apparatus.

2. Discussion of the Related Art

In a fabrication process of a semiconductor device, plasma is often used. For example, plasma is used in a dry etching process, a chemical vapor deposition (CVD) process and a sputtering process. Recently, high density plasma (HDP) between about 1×10¹¹ ions/cm³ to about 1×10¹² ions/cm³ is used to increase an efficiency of process. The HDP is obtained through generating inductively coupled plasma (ICP) by using an antenna electrode.

FIG. 1 is a schematic cross-sectional view of a related art antenna electrode. As shown in FIG. 1, the antenna electrode 10 is composed of a copper tube 100 and a silver coating layer 110. The silver coating layer 110 is coated on an outer surface of the copper tube 100. When a high frequency power is applied to the antenna electrode 10, a current flows through the copper tube 100 and the silver coating layer 110. Since the copper tube 100 and the silver coating layer 110 are heated by the current, a cooling water flows through an interior of the copper tube 100 to cool the copper tube 100 and the silver coating layer 110.

Generally, as a frequency of a current flowing through a conductive line increases, the current flows through a more outer region of the conductive line. A penetration distance (or a penetration thickness) of the current flowing through the conductive line is referred to as a skin depth, which is determined by the following equation.

δ=1/(π·f·μ·σ),

(δ: skin depth, σ: conductivity of a medium, f: frequency of a current, μ: permeability of medium)

The skin depth means that a current flows only through an outer region of the skin depth and does not flow through an inner region of the skin depth in cross-sectional view when a power is applied to a conductive line. For example, since the frequency of a direct current (DC) is 0, the skin depth for the DC becomes infinite. This means that the DC flows through entire cross-section of the conductive line. When a power of 60 Hz is applied to the conductive line, the skin depth is about 0.86 cm. A current flows only through a cross-section between the outer surface and about 0.86 cm from the outer surface and does not flow through an interior of the skin depth. When a power of 1 MHz is applied to the conductive line, the skin depth is about 0.007 cm. Therefore, a current flows through almost the outer surface of the conductive line.

Considering the equation of a skin depth, when a frequency of a power applied to the antenna electrode 10 is between about 300 KHz to about 300 MHz, a current flows almost through the silver coating layer 110 and an outer surface of the copper tube 100. Accordingly, the outer surface of the copper tube is heated and oxidized. Therefore, when a high frequency power is applied to the antenna electrode 10 for a long time period, the copper tube 100 is corroded and the silver coating layer 110 is also damaged. In result, a resistance of the antenna electrode 10 increases and a current flowing through the antenna electrode 10 is reduced.

### SUMMARY OF THE INVENTION

Accordingly, the present invention is directed to an antenna electrode for an inductively coupled plasma generation apparatus that substantially obviates one or more of problems due to limitations and disadvantages of the related art.

An advantage of the present invention is to provide an antenna electrode for an inductively coupled plasma (ICP) generation apparatus that is not corroded even when used for a long time period.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an antenna electrode for an inductively coupled plasma generation apparatus includes: a copper tube; a silver layer on an outer surface of the copper tube; and a first insulating layer on the silver layer.

The copper tube has an inner hollow through which a cooling water flows. A high frequency power is applied to the copper tube. The antenna electrode farther includes a second insulating layer on an inner surface of the copper tube. The first and second insulating layers have a thickness between about 1 μm to about 500 μm and may be formed through one of Teflon and ceramic coating.

In another aspect, an antenna electrode for an inductively coupled plasma generation apparatus includes: an oxygen-free copper tube; and a first insulating layer on an outer surface of the oxygen-free copper tube.

The oxygen-free copper tube has an inner hollow through which a cooling water flows. A high frequency power is applied to the oxygen-free copper tube. The antenna electrode further includes a second insulating layer on an inner surface of the oxygen-free copper tube. The first and second insulating layers have a thickness between about 1 μm to about 500 μm and may be formed through one of Teflon and ceramic coating.

It is to be understood that both the foregoing general description and the following detailed description are exemplary and explanatory and are intended to provide further explanation of the invention as claimed.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic cross-sectional view of a related art antenna electrode;

FIGS. 2A and 2B are schematic cross-sectional views of an antenna electrode for an inductively coupled plasma generation apparatus according to an exemplary embodiment of the present invention; and

FIGS. 3A and 3B are schematic cross-sectional views of an antenna electrode for an inductively coupled plasma generation apparatus according to another exemplary embodiment of the present invention.

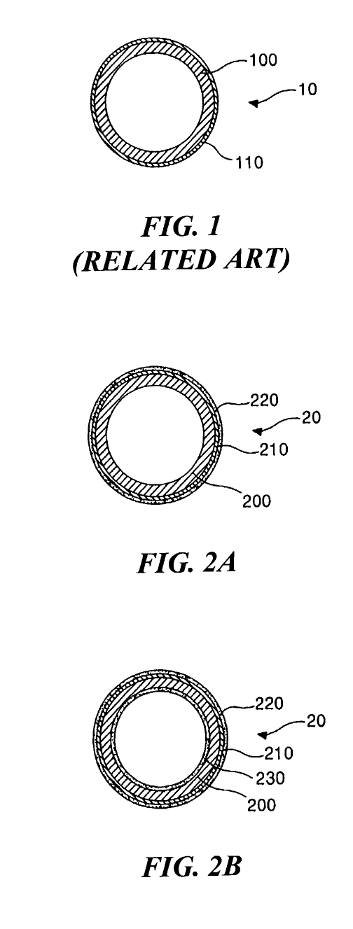

### DETAILED DESCRIPTION OF THE ILLUSTRATED EMBODIMENTS

Reference will now be made in detail to the illustrated embodiments of the present invention, which are illustrated in the accompanying drawings.

FIGS. 2A and 2B are schematic cross-sectional views of an antenna electrode for an inductively coupled plasma generation apparatus according to an exemplary embodiment of the present invention.

In FIG. 2A, a silver layer 210 is formed on an outer surface of a copper tube 200. A first insulating layer 220 having a thickness between about 1 μm to about 500 μm is formed on the silver layer 210. The first insulating layer 220 prevents that an exterior oxygen ion penetrates the silver layer 210 into the outer surface of the copper tube 200. Accordingly, the copper tube 200 is not oxidized and not corroded even when a high frequency power is applied to the copper tube 200 for a long time period. Therefore, a resistance of an antenna electrode 20 including the copper tube 200, the silver layer 210 and the first insulating layer 220 does not increase, and a current flowing through the antenna electrode 20 are not reduced.

In FIG. 2B, a second insulating layer 230 is further formed on an inner surface of the copper tube 200. Similarly in the first insulating layer 220, the second insulating layer 230 prevents that an oxygen ion of a cooling water penetrates the copper tube 200 into the outer surface of the copper tube 200.

The first and second insulating layers 220 and 230 may be formed through Teflon or ceramic coating. Since the Teflon coating has a high heat resistance and high chemical resistance, the Teflon coating is very stable at high temperature and chemically. Moreover, since the Teflon coating has a good insulating property, a surface resistance of the Teflon coating is high and a RF power loss due to a permittivity is small.

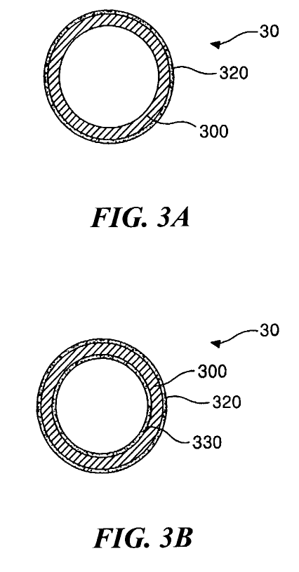

FIGS. 3A and 3B are schematic cross-sectional views of an antenna electrode for an inductively coupled plasma generation apparatus according to another exemplary embodiment of the present invention.

In FIG. 3A, a first insulating layer 320 is formed on an outer surface of a oxygen-free copper tube 300 (OFC tube). Oxygen-free copper (OFC) has oxygen less than 0.001%. Since the OFC has a good electric conductivity and it is easy to process the OFC, the OFC is widely used in electronic devices. Therefore, a silver layer 210 (of FIG. 2A) can be omitted and an antenna electrode 30 includes just the OFC tube 300 and the first insulating layer 320. As in FIG. 2A, the first insulating layer 320 prevents that an exterior oxygen ion contacts the outer surface of the OFC tube 300.

In FIG. 3B, a second insulating layer 330 is formed on an inner surface of the OFC tube 300. As in FIG. 2B, the second insulating layer 330 prevents that an oxygen ion of a cooling water penetrates the OFC tube 300 into the outer surface of the OFC tube 300.

In the present invention, since a corrosion of an outer surface of an antenna electrode is prevented by first and second insulating layers, an efficiency of a high frequency power is not reduced even when used for a long time period.

It will be apparent to those skilled in the art that various modifications and variations can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. An antenna electrode for an inductively coupled plasma generation apparatus, comprising:
a copper tube;
a silver layer on an outer surface of the copper tube; and
a first insulating layer on the silver layer.

2. The antenna electrode according to claim 1, wherein the first insulating layer has a thickness between about 1 μm to about 500 μm.

3. The antenna electrode according to claim 1, wherein the first insulating layer is formed through one of Teflon and ceramic coating.

4. The antenna electrode according to claim 1, wherein the copper tube has an inner hollow.

5. The antenna electrode according to claim 4, wherein a cooling water flows through the inner hollow.

6. The antenna electrode according to claim 1, wherein a high frequency power is applied to the copper tube.

7. The antenna electrode according to claim 1, further comprising a second insulating layer on an inner surface of the copper tube.

8. The antenna electrode according to claim 7, wherein the second insulating layer has a thickness between about 1 μm to about 500 μm.

9. The antenna electrode according to claim 7, wherein the second insulating layer is formed through one of Teflon and ceramic coating.

10. An antenna electrode for an inductively coupled plasma generation apparatus, comprising:
an oxygen-free copper tube; and
a first insulating layer on an outer surface of the oxygen-free copper tube.

11. The antenna electrode according to claim 10, wherein the first insulating layer has a thickness between about 1 μm to about 500 μm.

12. The antenna electrode according to claim 10, wherein the first insulating layer is formed through one of Teflon and ceramic coating.

13. The antenna electrode according to claim 10, wherein the oxygen-free copper tube has an inner hollow.

14. The antenna electrode according to claim 13, wherein a cooling water flows through the inner hollow.

15. The antenna electrode according to claim 10, wherein a high frequency power is applied to the oxygen-free copper tube.

16. The antenna electrode according to claim 10, further comprising a second insulating layer on an inner surface of the oxygen-free copper tube.

17. The antenna electrode according to claim 16, wherein the second insulating layer has a thickness between about 1 μm to about 500 μm.

18. The antenna electrode according to claim 16, wherein the second insulating layer is formed through one of Teflon and ceramic coating.
